(19) United States
(12) Patent Application Publication
(10) Pub. No.: US 2016/0045784 A1
(43) Pub. Date: Feb. 18, 2016

(54) WRISTWATCH-TYPE SWING MEASUREMENT DEVICE WITH ACCELERATION SENSOR AND AUTOMATIC DRIVE METHOD USING CHARACTERISTIC MOTION EXTRACTION BY SAME

(71) Applicant: DS TEK INC., Guro-gu, Seoul (KR)

(72) Inventors: Jong Moon KIM, Seoul (KR); Jae Bum CHO, Seoul (KR)

(21) Appl. No.: 14/780,064

(22) PCT Filed: Dec. 16, 2013
(86) PCT No.: PCT/KR2013/011631

§ 371 Date: Sep. 25, 2015

(30) Foreign Application Priority Data
Mar. 28, 2013 (KR) 10-2013-0033793

(51) Int. Cl. A63B 24/00; G01P 15/18

(52) U.S. Cl. CPC A63B 24/0003; G01P 15/18

(57) ABSTRACT

The present invention relates to a wristwatch-type swing measurement device with an acceleration sensor for automatic drive by extracting the characteristics of a two-step motion produced by the movement of an arm or a leg in a ball game and a method for driving the swing measurement device. A wristwatch-type swing measurement device according to the present invention includes a body (1) and a band (2) detachably attached to each other, wherein the body includes a case (3) enclosing a processor part (4), a sensor part (5), an input/output part (6), and a power supply part (7), and the band (2) is designed to have a band length adjustable according to the size of the wrist, the ankle, or the grip of an exerciser. The processor part (4) consists of a processor (11) and a memory (12), the sensor part (5) consists of an acceleration sensor (13), the input/output part (6) consists of at least one of an LCD (18) and a speaker, the power supply part (7) consists of a battery (14) and a charging circuit (15). The processor (11) calculates the present measurement according to the characteristics of a swing motion based on the acceleration detected by the acceleration sensor so as to update the maximum value stored in the memory with the present measurement and to control the input/output part to generate an event for notifying the user of the revision of the maximum value, if the present measurement is greater than the maximum value stored in the memory.

### TECHNICAL FIELD

The present invention relates to a wristwatch-type swing measurement device which can be automatically driven by extracting characteristics of a two-step motion generated by the movement of an arm or a leg in a ball game and includes an acceleration sensor, and to a method for automatically driving the wristwatch-type swing measurement device by using an extraction of a characteristic movement of the swing measurement device.

### BACKGROUND ART

Regarding an exercise using the force of hand or foot, many attempts are being made to measure the movement speed of wrist or foot.

At present, the speed is measured by using a specially designed measurement device. Ordinarily, such a measurement is performed when a person moves in front of the measurement device in accordance with the instruction of an operator.

The most commonly used method is to photograph a movement by using a camera, to analyze the movement line through the photographs and to calculate the movement speed.

Representatively, in a ball game like golf, tennis, and ping-pong, this method is used to analyze a swing posture.

### PRIOR ART DOCUMENT

### Patent Document

1. Korean Patent Application Laid-Open Publication No. 10-2011-0120281
2. Korean Registered Patent Publication No. 10-0815832

### DISCLOSURE

### Technical Problem

The object of the present invention is to provide a wristwatch-type swing measurement device which is attachable to a wrist, an ankle, an exerciser, etc., and is automatically driven according to the characteristics of a swing movement in which a two-step motion is successively performed, so that various exercise-related data (for example, the maximum power or speed, exercise tempo, etc.) can be obtained, and to provide a method for automatically driving the swing measurement device.

For this, in the embodiment of the present invention, the wristwatch-type swing measurement device is configured by using a micro electro mechanical system (MEMS) type acceleration sensor which is formed in the form of an integrated circuit (IC) and is much used recently.

A physical quantity which is obtained by using a measurement value (acceleration value) of the acceleration sensor includes a force and a speed as shown in the following equation.

A. force=mass=acceleration

B. speed=acceleration=time

Generally, a physical quantity to be obtained from data analysis for performance improvement is a maximum speed. In the embodiment of the present invention, every time when the maximum speed is obtained, the value of the maximum speed continues to be updated.

The characteristic of the swing movement is to obtain the maximum speed through the two-step motion.

For example, the motion of a bowling game is divided into a motion to pull backward a hand and a motion to consecutively push forward a hand.

In the two-step motion, the wristwatch-type swing measurement device according to the embodiment of the present invention calculates automatically the force or speed and extracts a characteristic movement.

From this point of view, there is a difference between the wristwatch-type swing measurement device according to the embodiment of the present invention and conventional measurement devices which perform measurements and acquire data in accordance with the control and instruction of an operator. Besides, the swing measurement device according to the embodiment of the present invention may be used in the same manner to analyze a one-step motion as well as the two-step motion.

Also, the object of the present invention is to calculate the force or speed based on the acceleration value measured by the acceleration sensor (e.g., a three-dimensional acceleration sensor) and to find out the maximum value according to the change of the two-step motion and spending time or exercise tempo for each step, thereby providing a method for automatically driving the wristwatch-type swing measurement device in accordance with the characteristics of the swing movement. This automatic driving method is different from a driving method according to the operation of a switch or post data processing.

Here, the automatically driving method does not mean that the measurement is started and ended by the manual operation of a switch, but means that the wristwatch-type swing measurement device detects and analyzes a movement of an exercise, and then automatically displays the measurement on an output unit, or detects the characteristics of a swing movement, and then automatically controls the on/off of the input/output units of the wristwatch-type swing measurement device.

Also, the present invention includes that when there is a long interval between the motions of the two-step motion which is successively performed, the interval is reset such that the two-step motion can be recognized as one movement.

### Technical Solution

The characteristics of the configurations of the wristwatch-type swing measurement device according to the embodiment of the present invention and a method for automatically driving the swing measurement device by using an extraction of a characteristic movement of the swing measurement device will be described as follows.

[1] A wristwatch-type swing measurement device including a body and a band which are detachably attached to each other. The body includes a case, a processor part, a sensor part, an input/output part, and a power supply part which are included in the case. A length of the band is adjusted according to the size of a wrist, an ankle or a grip of an exerciser. The processor part includes a processor and a memory. The sensor part includes an acceleration sensor. The input/output part includes at least one of an LCD and a speaker. The power supply part includes a battery and a charging circuit. The processor calculates a current measurement value according to characteristics of a swing movement on the basis of an acceleration value measured by the acceleration sensor, updates a maximum value stored in the memory with the current measurement value when the current measurement value is greater than the maximum value stored in the memory, and controls the input/output part to generate an event for notifying a user of the update of the maximum value.

[2] In [1], the wristwatch-type swing measurement device further includes a mode selection function to automatically convert into any one of a movement mode and a power saving mode or to manually select. In the power saving mode, the measurement is automatically performed continually within the measurement device. When the current measurement value according to a movement of the acceleration sensor in the geocentric direction (Z-axis direction) is greater than an event occurrence value (threshold value) stored in the memory, the processor causes the input/output part 6 to be in an on-state.

[3] In [1] or [2], the input/output part further includes a USB port 16 and performs a data communication with an external device by connecting a USB connector to the USB port.

[4] A method for automatically driving the wristwatch-type swing measurement device disclosed in [1] or [2] by using an extraction of a characteristic movement of the swing measurement device. When the current measurement value is greater than the maximum value, the processor updates continually a previous maximum value stored in the memory with the current measurement value, so that the current measurement value is obtained as the maximum value.

[5] In [4], in the swing movement in which a two-step motion is successively performed, two current measurement values calculated from a maximum acceleration value in a section in which the acceleration value measured by the acceleration sensor continually increases are temporarily stored in the memory, and the processor automatically analyzes characteristics of the two-step motion, which correspond to the two current measurement values and determines whether the event occurs or not.

[6] In [5], in the swing movement in which a two-step motion is successively performed, the processor determines a motion start point, an end point, and a middle point of the two-step motion through a combination of a predetermined event occurrence value, an increasing slope in a section in which the acceleration value measured by the acceleration sensor continually increases, and a decreasing slope in a section in which the acceleration value continually decreases.

In [7] In[6], the processor calculates and stores a first-step consumption time, a second-step consumption time, a motion stop time, and an exercise tempo by using the motion start point, the end point, and the middle point.

8] In [7], the event occurs only for a predetermined maintenance time period and is automatically initialized after the maintenance time period.

[9] In [7], the event occurs only for a predetermined maintenance time period and is automatically initialized after the maintenance time period.

### Advantageous Effects

Through the wristwatch-type swing measurement device according to the embodiment of the present invention, the acceleration, speed, and force can be automatically calculated by using the acceleration sensor, the operations of the acceleration sensor and LCD can be automatically controlled by a processor when the characteristic movement of an exercise is extracted, and various exercise-related data inputted to a memory can be automatically updated. The swing measurement device can be installed and used on the equipment of a sport using a bat, for example, baseball, golf, tennis, etc., as well as on a wrist.

### DESCRIPTION OF DRAWINGS

FIG. 1a is a block diagram showing a configuration concept of a wristwatch-type swing measurement device according to an embodiment of the present invention;

FIG. 1b is a block diagram showing a configuration of one example of the wristwatch-type swing measurement device according to the embodiment of the present invention;

FIG. 1c is a view showing a state where the wristwatch-type swing measurement device according to the embodiment of the present invention has been worn;

FIG. 2 is a motion analysis view for describing a concept of a method for automatically driving the wristwatch-type swing measurement device by using an extraction of a characteristic movement in accordance with the embodiment of the present invention;

FIG. 3 is a force-time graph or a speed (acceleration)-time graph for describing a concept of the method for automatically driving the wristwatch-type swing measurement device by using an extraction of a characteristic movement in accordance with the embodiment of the present invention;

FIG. 4 is a flowchart for describing a concept of the method for automatically driving the wristwatch-type swing measurement device by using an extraction of a characteristic movement in accordance with the embodiment of the present invention;

FIG. 5 is a motion point decision graph for describing a concept of the method for automatically driving the wristwatch-type swing measurement device by using an extraction of a characteristic movement in accordance with the embodiment of the present invention;

FIG. 6 is a view showing three-axis values of the acceleration in the wristwatch-type swing measurement device according to the embodiment of the present invention; and

FIG. 7 is a view showing that the three-axis values of the acceleration measured by the wristwatch-type swing measurement device according to the embodiment of the present invention is transmitted to other linked electronic devices.

### MODE FOR INVENTION

Hereafter, a wristwatch-type swing measurement device with an acceleration sensor according to the embodiment of the present invention (hereafter, briefly referred to as a swing measurement device) and a method for automatically driving the swing measurement device by using an extraction of a characteristic movement of the swing measurement device will be described in detail with reference to the accompanying drawings.

### The Structure of the Swing Measurement Device

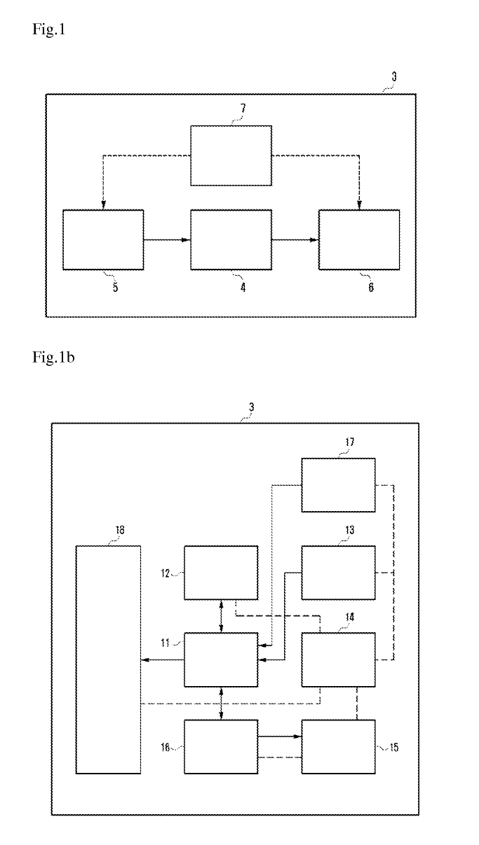

As shown in FIGS. 1a and 1c, the swing measurement device provided by the embodiment of the present invention includes a body 1 and a band 2. Like a watch body and a watch strap, the body 1 and the band 2 are detachably attached to each other. Here, in FIGS. 1a and 1b, a solid line represents a data or a control instruction, and a dotted line represents electric power.

The body 1 includes a case 3 and a processor part 4, a sensor part 5, an input/output part 6, and a power supply part 7 which are included in the case.

The length of the band 2 which is detachably attached to the case 3 of the body can be adjusted according to the size of the wrist, the ankle, or the grip of an exerciser.

FIG. 1b shows a configuration of the body of the swing measurement device according to the embodiment of the present invention. The body includes a processor 11 corresponding to the processor part 4, a memory 12, an acceleration sensor 13 corresponding to the sensor part 5, an LCD 18 corresponding to the input/output part 6, and a battery 14 corresponding to the power supply part 7.

The case 3 is assemblable and disassemblable such that parts can be repaired and replaced and the battery is replaced, etc. The case may have a thin rectangular shape like a smartphone, a flat circular shape like a wristwatch, or a new shape to which design elements have been added.

Here, the sensor part 5 may further include other sensors 17 including a GPS sensor or a pressure sensor, etc. Also, the input/output part 6 may further include a USB port 16. Also, the power supply part 7 may further include a charging circuit 15.

Particularly, when the input/output part 6 includes the USB port 16, the USB port 16 may function as not only the input/output part but also a power supply terminal

Also, the input/output part 6 may be configured by not only the LCD but also a user interface (e.g., a speaker) to which a manner different from that of the LCD is applied or may further include such an interface.

<The Concept of a Method for Automatically Driving by Using an Extraction of a Characteristic Movement >

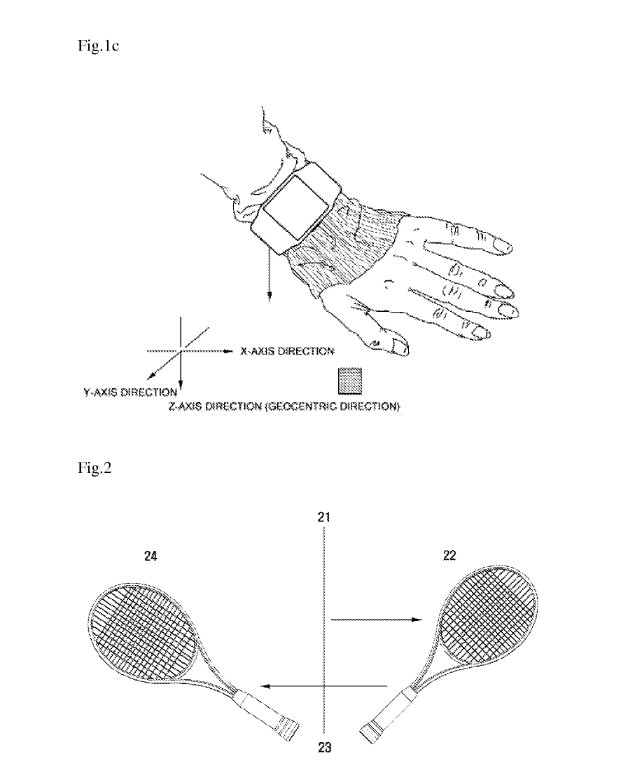

The accompanying FIG. 2 is a two-step motion analysis view for describing a concept of extracting a characteristic movement in accordance with the embodiment of the present invention. On the basis of a stationary position 21 prior to the change of the motion, the movement motion produced in most sports activities, for example, badminton, bowling, ping-pong, soccer, volleyball, golf, etc., including tennis is divided into a backward motion in which one's body or an exerciser moves in an opposite direction to a target direction so as to generate or transmit more force and a forward motion in which one's body or an exerciser moves in the same direction as a target direction, passing through the stationary position.

The backward motion and forward motion are successively performed like water flowing in sports activities, it is difficult to clearly distinguish the two motions.

For this reason, in the embodiment of the present invention, a position prior to the change of posture or motion (for example, a position in which a person is standing still without moving) is defined as the stationary position 21. Also, a motion to move an arm, a leg or an exerciser behind one's back from the stationary position is defined as the backward motion. Also, a motion to move an arm, a leg or an exerciser forward in front of the stationary position is defined as the forward motion. For convenience of description, a position at which an arm, a leg or an exerciser moves backward to the maximum degree from the stationary position 21 is defined as a backward position 22. A position at the time when an arm, a leg or an exerciser returns to the stationary position from the backward position is defined as a return position 23. A position at which an arm, a leg or an exerciser moves forward to the maximum degree from the return position is defined as a forward position 24. Although the positions of the stationary position and the return position are the same as each other, the motion states of them are quite different from each other. Therefore, they are distinguished as described above.

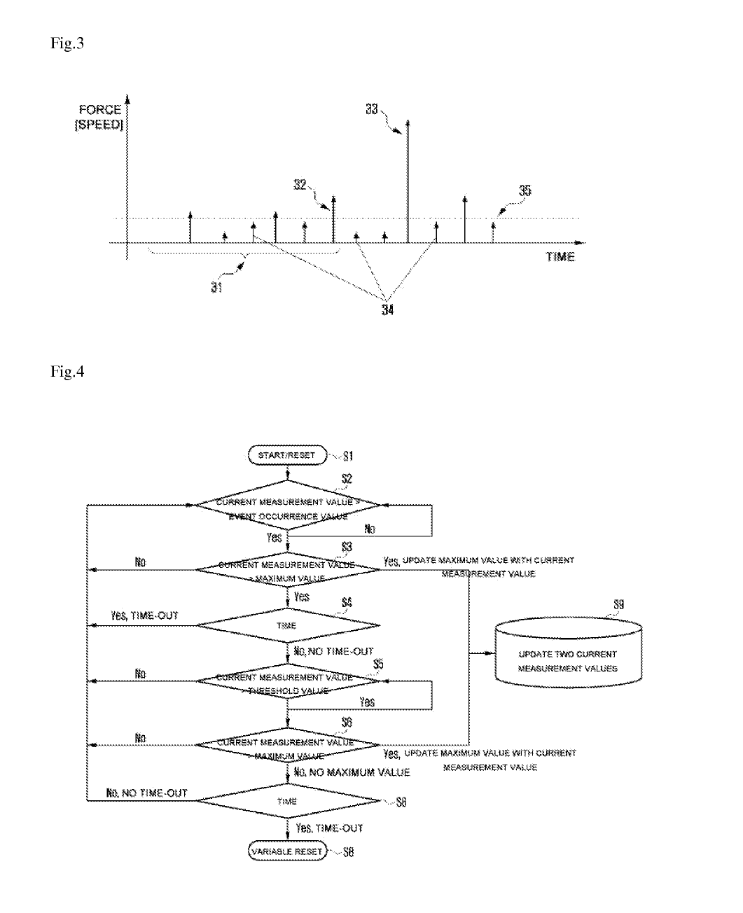

The accompanying FIG. 3 is a force-time graph or a speed (acceleration)-time graph for describing a concept of extracting a characteristic movement in accordance with the embodiment of the present invention.

In a backward moving section 31 in which the backward motion is performed, the processor 11 calculates a force and a speed (or acceleration) based on the measurement value from the acceleration sensor 13.

In the backward moving section 31, an inactive value 34 less than an event occurrence value (threshold value) 35 mainly occurs. Also, a maximum moving backward value 32 exceeding the event occurrence value 35 may occur.

The inactive value 34 occurs at a certain point of time when the two-step motion is successively performed. However, in most cases, the inactive value 34 occurs when the motion hesitates momentarily.

The event occurrence value 35 is an initially set value for allowing the swing measurement device according to the embodiment of the present invention to be automatically driven. The event occurrence value 35 is an acceleration, speed or force.

The maximum moving backward value 32 calculated or measured during the sports activities cannot be greater than a maximum moving forward value 33 due to the structure of a physical body.

Contrarily, the swing measurement device according to the embodiment of the present invention is configured such that at least one event occurs when one's body or an exerciser moves from the backward position 22 to the forward position 24. Therefore, the event occurrence value 35 is greater than the maximum moving forward value 33.

The event occurrence value 35 is set by a user according to his/her own ability or is arbitrarily set by a manufacturer. In a case where a manufacture sets the event occurrence value 35, it is desirable to make a reference to research results of a research group, for example, a sports science institute.

Meanwhile, when an event occurs several times in a series of motions, the battery 14 may be consumed rapidly. Therefore, under a condition that the maximum moving backward value 32 is less than the maximum moving forward value 33, the event occurrence value 35 may set such that the event does not occur even when the maximum moving backward value 32 is greater than the event occurrence value 35. The event occurs only one time in series of motions, for example, by programming the processor 11 to control the input/output part 6 at the point of time when the maximum moving forward value 33 is measured.

The accompanying FIG. 4 is a flowchart for describing a concept of the method for automatically driving the wristwatch-type swing measurement device by using an extraction of a characteristic movement in accordance with the embodiment of the present invention. The step of “end” is not included at the end of the flowchart.

All the previous measurement values are initialized in a start/reset step S1 and a variable reset step S8. The variable reset step S8 is performed every certain time.

Also, a reset time is reset when the maximum value (maximum moving backward value and maximum moving forward value) is measured.

When a current measurement value is greater than the previous maximum value, the processor 11 updates the maximum value stored in the memory 12 with the current measurement (S3 and S6) and automatically measures the two-step motion shown in FIG. 2.

Meanwhile, if a currently measurement value is less than a threshold value, the currently measurement value is ignored (S2 and S5).

A meaningful measurement value in most sports activities is the maximum value, the threshold value can be set to a very large value.

In a first-step consumption time calculation step S4 and a second-step consumption time calculation step 7, when a consumption time reaches a timeout, the steps S4 and S7 start again. For example, if a timeout condition is met in the first-step consumption time calculation step S4 and the next step S5 is not performed, the previous steps S1 to S4 related to the first-step motion are repeatedly performed, and if the timeout condition is met in the second-step consumption time calculation step 7, the variable reset step S8 is performed and thus, the variable is initialized, so that the force and speed (acceleration), etc., can be newly measured. This means that a stable motion can be performed through a system initialization.

The accompanying FIG. 5 is a motion point decision graph for describing a concept of the method for automatically driving the wristwatch-type swing measurement device by using an extraction of a characteristic movement in accordance with the embodiment of the present invention. FIG. 5 shows a method for determining a start point, a middle point, and an end point in the two-step motion.

During the determination of the motion start point, middle point, and end point, a consumption time (or tempo) for each step in the two-step motion is calculated.

When the start point, middle point, and end point are determined, various times related to the movement, that is, the first-step consumption time, the second-step consumption time, motion stop time, etc., are calculated according to the time interval among the start point, middle point, and end point.

A motion start point 52 is found through a combination of the event occurrence value 35 and an increasing slope 51 which increases by the start of a corresponding motion (for example, the backward motion and the forward motion). The end point 54 is found through a combination of the event occurrence value and a decreasing slope 53 which decreases by the completion of a corresponding motion. Between the start point and the end point, the middle point 55 where the motion is changed can be found in the aforementioned manner.

Even when there is a long interval between the first-step motion (e.g., backward motion) and the second-step motion (e.g., forward motion), which are successively performed, a reset can occur so as to consecutively measure the two-step motion. This means that the motion flow is optimized by analyzing the change of the motion of the movement.

Referring back to FIG. 1c, a human can easily recognize a Z-axis direction (geocentric direction). In a case where the wristwatch-type swing measurement device according to the embodiment of the present invention includes a three-dimensional acceleration sensor, when an arm, a leg or an exerciser moves rapidly in a Z-axis direction among X, Y, and Z axis directions, the swing measurement device detects the movement and causes the LCD 18 to be in an on-state, so that the user is able to see the LCD 18. Similarly to this, the LCD 18 may be programmed to be driven when a force greater than a certain value is generated. By doing this, when the two-step motion is completed, the LCD is automatically turned on without other operations, so that the user is able to see the LCD 18.

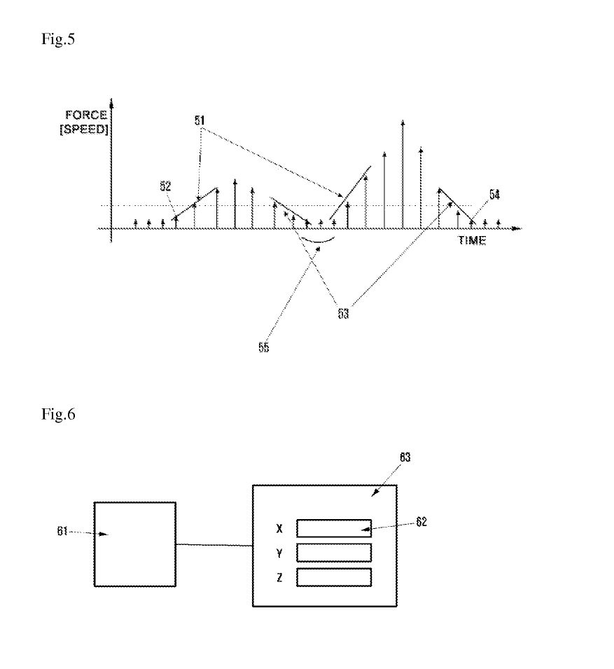

FIG. 6 shows that three-axis acceleration values measured by the three-dimensional acceleration sensor of the swing measurement device according to the embodiment of the present invention are displayed on a display screen 63 of the LCD 18. As shown in FIG. 6, the acceleration value of each of the X, Y, and Z axes is displayed on the display screen 63. The form of display of the acceleration value is not limited to the form shown in FIG. 6.

A processor 61 of the swing measurement device according to the embodiment of the present invention stores the three-axis acceleration values used to calculate the maximum moving forward value 33, i.e., the maximum speed value, and displays on the display screen 63 of the LCD 18, thereby allowing the user to check the actual acceleration values of the X, Y, and Z axes. The displayed three-axis acceleration values correspond to respective axis acceleration values at the time of obtaining the maximum swing speed. Since then when the three-axis acceleration values are always the same as each other at the maximum speed, this means that the moving direction of a ball is the same direction. As such, in the swing measurement device according to the embodiment of the present invention, the user is allowed to check the three-axis acceleration values when the user swings with the maximum moving forward value 33, thereby checking whether a force which is applied in the directions of the three axes is constant or not.

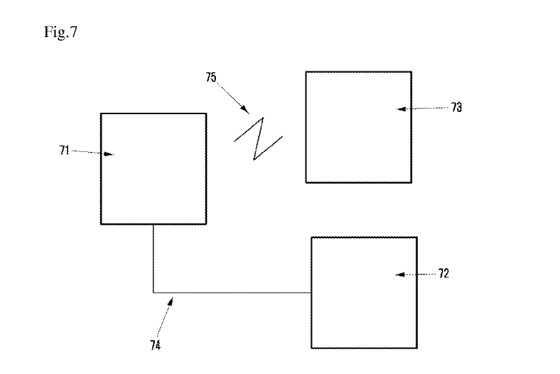

FIG. 7 is a view showing that the three-axis values of the acceleration measured by the swing measurement device according to the embodiment of the present invention is transmitted to other linked electronic devices. Other electronic devices shown in FIG. 7 include a computer 72 and a smartphone 73. However, other electronic devices are limited to this. All kinds of electronic devices equipped with an interface capable of being connected to the swing measurement device according to the embodiment of the present invention in a wired or wireless manner can be used.

The computer 72 may be connected through a USB terminal (see reference numeral 74). A wireless terminal like the smartphone 73 may be connected in a wireless manner like Bluetooth, a NFC communication, etc. The computer 72 can be also connected wirelessly through Bluetooth, Wi-Fi, etc., and a portable terminal like the smartphone 73 can be also connected in a wired manner through a data cable, etc.

The X, Y, and Z axis acceleration values used to obtain the maximum speed value from the maximum moving forward value 33 are transmitted to other electronic devices connected as described above, and can be displayed on the user personal computer 72 or smartphone 73.

Since the three-axis acceleration values which are output to the acceleration sensor 13 are a large number of several hundreds of data per second, it is inefficient to store all of the data. Contrarily, the processor of the swing measurement device according to the embodiment of the present invention stores only the three-axis acceleration values in a case where the maximum moving forward value 33 is obtained, so that it is possible to efficiently use a memory space of the swing measurement device and to store the data for determining the optimal swing.

Through use of the three-axis acceleration values obtained by the acceleration sensor 13, the acceleration value or speed value related to the swing of the user can be obtained. That is to say, when the three-axis acceleration values are transmitted to the computer or smartphone in a wired or wireless manner, a swing trajectory is estimated and displayed based on the three-axis acceleration values by a program installed in the computer or smartphone. The acceleration value or speed value related to one swing can be calculated from the three-axis acceleration values, and the actual swing trajectory can be calculated by the acceleration value or speed value.

As such, in the swing measurement device according to the embodiment of the present invention, the three-axis acceleration values measured at the time of performing an optimal swing are transmitted to another electronic device, so that the user is allowed to check the optimal swing trajectory through a program installed in the electronic device. Through this, the user is able to prevent his/her swing from deviating from the optimal swing.

[DESCRIPTION OF REFERENCE NUMERALS]

| | |
|---|---|
| 1: body | 2: band |
| 3: case | 4: processor part |

| | |
|---|---|
| 5: sensor part | 6: input/output part |
| 7: power supply part | 11: processor |

| | |
|---|---|
| 12: memory | 13: acceleration sensor |

| | |
|---|---|
| 14: battery | 15: charging circuit |
| 16: USB port | 17: other sensors |

| | |
|---|---|
| 18: LCD | 21: stationary position |
| 22: backward position | 23: return position |
| 24: forward position | 31: backward moving section |

| 32: maximum moving backward value | 33: maximum moving forward |
|---|---|
| | value |

| | |
|---|---|
| 34: inactive value | 35: event occurrence value |
| 51: increasing slope | 52: start point |
| 53: decreasing slope | 54: end point |

55: middle point

1. A wristwatch-type swing measurement device comprising a body and a band which are detachably attached to each other,
wherein the body comprises a case, a processor part, a sensor part, an input/output part, and a power supply part which are comprised in the case,
wherein a length of the band is adjusted according to the size of a wrist, an ankle or a grip of an exerciser,
wherein the processor part comprises a processor and a memory,
wherein the sensor part comprises an acceleration sensor,
wherein the input/output part comprises at least one of an LCD and a speaker,
wherein the power supply part comprises a battery and a charging circuit,
and wherein the processor calculates a current measurement value according to characteristics of a swing movement on the basis of an acceleration value measured by the acceleration sensor, updates a maximum value stored in the memory with the current measurement value when the current measurement value is greater than the maximum value stored in the memory, and controls the input/output part to generate an event for notifying a user of the update of the maximum value.

2. The wristwatch-type swing measurement device of claim 1, further comprising a mode selection function to select any one of a movement mode and a power saving mode, wherein, in the power saving mode, when the current measurement value according to a movement of the acceleration sensor in the geocentric direction (Z-axis direction) is greater than a event occurrence value stored in the memory, the processor causes the input/output part to be in an on-state.

3. The wristwatch-type swing measurement device of claim 1, wherein the input/output part further comprises a USB port, and wherein the input/output part performs a data communication with an external device by connecting a USB connector to the USB port.

4. The wristwatch-type swing measurement device of claim 1, wherein the acceleration sensor measures X, Y, and Z axis acceleration values, wherein the LCD displays the X, Y, and Z axis acceleration values corresponding to the maximum value stored in the memory, and wherein the processor stores the displayed X, Y, and Z axis acceleration values in the memory.

5. The wristwatch-type swing measurement device of claim 4, further comprising a communication unit which transmits the X, Y, and Z axis acceleration values stored in the memory to an external electronic device.

6. A method for automatically driving the wristwatch-type swing measurement device disclosed in claim 1 by using an extraction of a characteristic movement of the swing measurement device, wherein, when the current measurement value is greater than the maximum value, the processor updates continually a previous maximum value stored in the memory with the current measurement value, so that the current measurement value is obtained as the maximum value.

7. The method of claim 6, wherein, in the swing movement in which a two-step motion is successively performed, two current measurement values calculated from a maximum acceleration value in a section in which the acceleration value measured by the acceleration sensor continually increases are temporarily stored in the memory, and the processor automatically analyzes characteristics of the two-step motion, which correspond to the two current measurement values and determines whether the event occurs or not.

8. The method of claim 6, wherein, in the swing movement in which a two-step motion is successively performed, the processor determines a motion start point, an end point, and a middle point of the two-step motion through a combination of a predetermined event occurrence value, an increasing slope in a section in which the acceleration value measured by the acceleration sensor continually increases, and a decreasing slope in a section in which the acceleration value continually decreases.

9. The method of claim 8, wherein the processor calculates and stores a first-step consumption time, a second-step consumption time, a motion stop time, and an exercise tempo by using the motion start point the end point, and the middle point.

10. The method of claim 9, wherein the event occurs only for a predetermined maintenance time period and is automatically initialized after the maintenance time period.

11. The method of claim 9, wherein a motion change point of the two-step motion is defined as a value less than the event occurrence value and is found by using the two current measurement values or by using the motion start point, the end point, and the middle point.
